(19) United States
(12) Patent Application Publication
(10) Pub. No.: US 2007/0086133 A1
(43) Pub. Date: Apr. 19, 2007

(54) Network system for safe connection of generation into a network power system

(75) Inventors: David G. Loucks, Coraopolis, PA (US); Thomas J. Kenny, Pittsburgh, PA (US); Martin Baier, Cranberry Township, PA (US)

Correspondence Address: MARTIN J. MORAN, ESQ.;Eaton Electrical, Inc., Technology & Quality Center, 170 Industry Drive, RIDC Park West, Pittsburgh, PA, 15275-1032, US

(73) Assignee: EATON CORPORATION

(21) Appl. No.: 11/252,459

(22) Filed: Oct. 18, 2005

(51) Int. Cl. H02H 3/18

(52) U.S. Cl. 361/84

(57) ABSTRACT

A network system includes a network bus structured to power plural network loads. A generator is structured to provide forward power flow to the network bus. A generator protector relay cooperates with the generator. Plural network protectors correspond to plural power source feeders, which are structured to provide forward power flow through corresponding network protectors to the network bus. Each network protector includes a network protector relay having an interface communicating power flow information to a communication network. A controller cooperates with the generator protector relay and includes an interface receiving the power flow information from the communication network and a processor determining whether there is forward power flow through the network protectors to the network bus. The processor enables the generator protector relay responsive to the forward power flow and reduces output from the generator responsive to the forward power flow being less than a predetermined amount.

### BACKGROUND OF THE INVENTION

1. Field of the Invention

This invention pertains generally to network systems and, more particularly, to such network systems for powering a plurality of network loads through a plurality of power source feeders, one or more generators, and a network bus.

2. Background Information

A network protector is a circuit breaker or other suitable switching device adapted to trip and open a power source, such as a feeder, upon detection of reverse power flow (i.e., power flowing through the power source and out of the network rather than into the network). Typically, overcurrent protection is provided by other devices, such as fuses in series with the network protector. The main function of the network protector is to automatically open upon detecting reverse power flow out of the network, and to close after the power from the respective power source has been restored. The overriding goal of a network system including plural network protectors is to electrically connect as many power sources as possible, thereby improving redundancy and, therefore, the reliability of the power sources.

Distribution networks are a type of electrical power distribution system used by utilities and relatively large industrial users to provide highly reliable power by connecting multiple sources of power supply to a common load. Because of the multiple sources, a malfunction of one or more power sources can often be tolerated without impact on the loads. To manage such multiple-source networks, the provision for safe and fully automatic connection of healthy power sources and disconnection of faulty power sources is necessary. Network protectors provide this provision automatically.

Because of the inherent network characteristic of zero tolerance for any power flowing out of a network, a network is not suited to export any power out of the network. This is the main reason why it has proven very difficult to electrically connect distributed generation to a network power system. Electrically connecting distributed generation to a network power system is desirable from both an improved redundancy/reliability standpoint and a cost of operation standpoint. The cost of operation becomes an issue if the distributed generator can produce electrical energy or power at a lower total cost than the cost to acquire an equivalent amount of electrical energy or power from the grid.

The problem is, however, that should the amount of locally generated electrical energy or power approach or exceed the requirements of the connected load, then undesirable opening of one or more network protectors may occur, thereby negatively impacting the network reliability. In the extreme case, all utility power sources could disconnect, thereby leaving the distributed generator to supply the entire load. This condition is called “islanding” and is a very undesirable condition because it is inevitably associated with network outage due to inability of the islanded network to automatically synchronize with the utility in order to restore its normal operation.

One prior proposal to address this problem consists of monitoring the power flow through individual network protectors and controlling the distributed generation output based upon the proximity of the network system to equilibrium (i.e., zero power flow across a network protector, which is an undesirable situation). This proposal is often called network underpower supervision and requires the connection of additional equipment to monitor for this condition and to control the operation of distributed generation, which is associated with significant costs.

FIG. 1 shows a system 1 for adding underpower sensing to each of a plurality of utility power sources, such as source feeders 2,4,6. This system 1 requires underpower relays, such as 8,10, for each of the respective utility power sources, such as 2,4. Additional underpower relays (not shown) are employed for each of the other source feeders, such as 6. This system 1 further requires that current sensing and voltage sensing wiring, such as 12,14, be brought out of each of the network protector relays (NPRs), such as 16,18, and be electrically connected to the externally mounted underpower relays 8,10, respectively. The network protector relays NPR 1 16 and NPR 2 18 cooperate with network protectors (NWPs) 20 and 22, respectively. The externally mounted underpower relays 8,10 cooperate to provide permissive signals 24,26 that are hard-wired to a generator protective relay (GPR) 28 of a distributed generator 30. Should any of the two or more underpower relays, such as 8,10, trip due to low forward power flow (from the utility (not shown) to the network loads 32), then the permissive circuit 34 is disabled and the distributed generator 30 shuts down. This system 1 also requires a relatively large enclosure 36 to hold the various underpower relays, such as 8,10, and other control devices (not shown), as well as substantial field interconnection wiring 12,14,34. Hence, this system 1 entails significant costs.

An additional difficulty associated with the conventional voltage (potential) and current sensing circuits available with network protectors is that these circuits require that the wires be brought outside of the protection provided by the network protector enclosure. Since the network protector enclosure is, many times, a submersible vessel, the wiring through that vessel boundary must be a submersible class fitting. Also, since the critical sensing wiring is being taken outside of the confines of the protected enclosure, those wires may be inadvertently opened or shorted. Furthermore, for installations where the associated network protectors are not in the same immediate proximity, this issue becomes even more difficult to man age.

In the case of current sensing wiring, open-circuited wiring will not only break the signal to the network protector relay, thus, causing a malfunction within the network protector, it will also most likely permanently damage the current sensing transformer. Replacing the current transformer requires a major repair operation that takes the network protector out of service for several hours. For voltage sensing wiring, if the wiring is short circuited, then the voltage difference on the wires goes to zero resulting in a malfunction of the voltage sensing system within the network protector. This is a critical problem since a main function of the network protector is to measure network and source voltage, compare them, and determine if it is safe to close the network protector or if the network protector should be opened. Regardless of the case, the faulty sensing will impair the critical network protector functionality, which may escalate the abnormal condition and seriously impact the reliability of the entire installation.

Accordingly, there is room for improvement in network systems.

### SUMMARY OF THE INVENTION

These needs and others are met by the present invention, which eliminates the concern of bringing current and voltage sensing wiring out of a network protector enclosure. This greatly reduces the installation cost and complexity by reducing the need to bring those wires outside of the network protector enclosure.

In accordance with one aspect of the invention, a network system for powering a plurality of network loads comprises: a network bus structured to power the network loads; a plurality of power source feeders; a communication network; a generator structured to provide forward power flow to the network bus; a generator protector relay cooperating with the generator; a plurality of network protectors corresponding to the power source feeders, the power source feeders being structured to provide forward power flow through corresponding ones of the network protectors to the network bus, each of the network protectors comprising a network protector relay including an interface communicating power flow information to the communication network; and a controller cooperating with the generator protector relay, the controller comprising an interface receiving the power flow information from the communication network and a processor determining whether there is forward power flow through the network protectors to the network bus, enabling the generator protector relay responsive to the forward power flow through the network protectors to the network bus, and reducing output from the generator responsive to the forward power flow through at least one of the network protectors being less than a predetermined amount.

The interfaces of the network protector relays may be associated with corresponding addresses; and the processor of the controller may comprise a polling table and an auto-learning routine, which auto-learns at least some of the interfaces of the network protector relays on the communication network, and which adds the corresponding addresses of the interfaces of the network protector relays to the polling table.

The controller may further comprise an output relay controlling the generator protector relay. The processor may de-energize the output relay responsive to the forward power flow through at least one of the network protectors being less than a predetermined setpoint, in order to shut down the generator.

The processor may de-energize the output relay responsive to loss of communication on the communication network, in order to shut down the generator.

The processor may repetitively poll the communication network to receive the power flow information from the communication network. The processor may re-energize the output relay responsive to the forward power flow being greater than the predetermined setpoint, in order to restart the generator.

The predetermined setpoint may be a first setpoint. The processor may comprise a second setpoint, which is greater than the first setpoint, and a predetermined period of time. The processor may re-energize the output relay responsive to the forward power flow being greater than the second setpoint for the predetermined period of time.

The generator may be at least one distributed generator including an input structured to adjust the forward power flow to the network bus. The processor may comprise an output having a bias signal structured to continuously, periodically or repetitively adjust the input of the at least one distributed generator.

The at least one distributed generator may be a plurality of distributed generators. The processor may further comprise a lower setpoint and an upper setpoint relative to an instantaneous value of the forward power flow between the lower and upper setpoints. The processor may adjust the bias signal of the output thereof to adjust the input of the distributed generators, or may select and adjust one of the distributed generators.

The processor may be structured to adjust power output from or trip at least one of the distributed generators based upon a predetermined count of the network protectors having the forward power flow through the network protectors to the network bus being less than a predetermined setpoint.

The processor may be structured to trip the at least one of the distributed generators based upon the predetermined count being less than the predetermined setpoint. The processor may be structured to reset the at least one of the distributed generators based upon the predetermined count being greater than the predetermined setpoint.

The generator may comprise a plurality of non-adjustable distributed generators. The controller may further comprise a plurality of shedding contacts to provide staged distributed generation shedding.

The controller may further comprise an output relay controlling the generator protector relay. The processor may energize the output relay responsive to the forward power flow through the network protectors to the network bus being greater than a predetermined setpoint.

### BRIEF DESCRIPTION OF THE DRAWINGS

A full understanding of the invention can be gained from the following description of the preferred embodiments when read in conjunction with the accompanying drawings in which:

FIG. 1 is a block diagram of a network protector system.

FIG. 2 is a block diagram of a network system including a distributed generation controller in accordance with the present invention.

FIGS. 3-5 are block diagrams of the distributed generation controller of FIG. 2 in accordance with other embodiments of the invention.

### DESCRIPTION OF THE PREFERRED EMBODIMENTS

As employed herein, the term “communication network” shall expressly exclude discrete current sensing conductor(s) and discrete voltage sensing conductor(s), and shall expressly include, but not be limited by, an INCOM network, a twisted pair daisy chain network, any local area network (LAN), a wide area network (WAN), a power line carrier network, a low-rate wireless personal area network (LR-WPAN), other types of wireless sensor networks, intranet, extranet, global communication network and/or the Internet.

The present invention is described in association with a network system including one or more distributed generators and power source feeders, although the invention is applicable to a wide range of network systems for network busses.

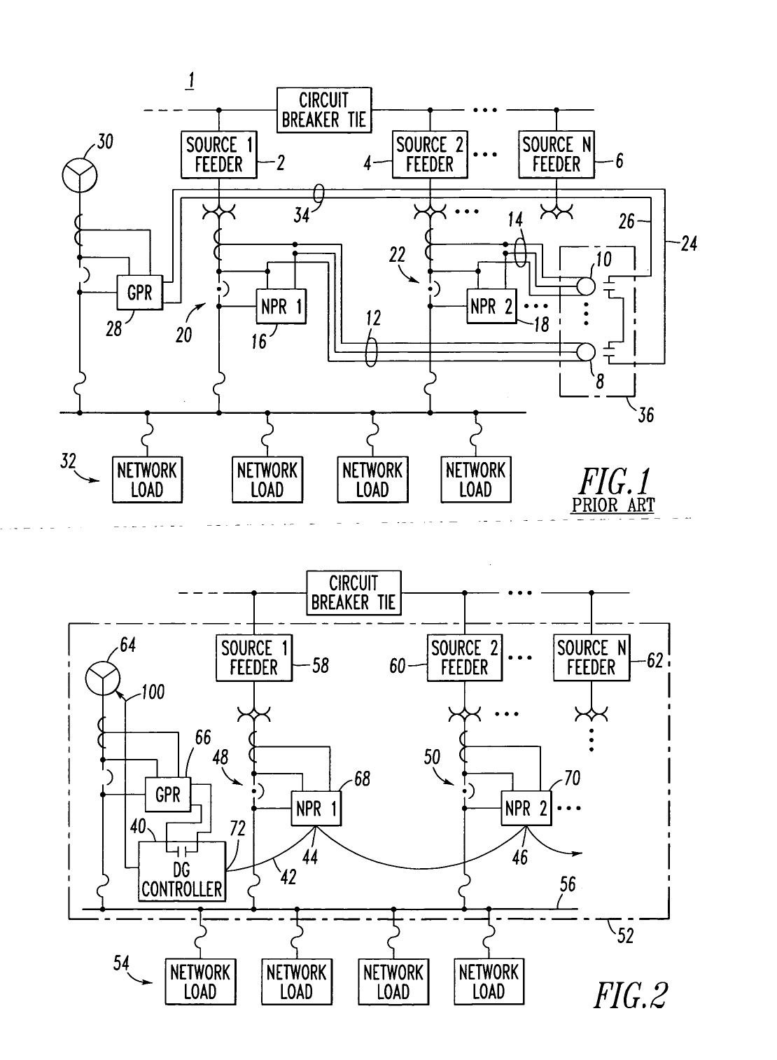

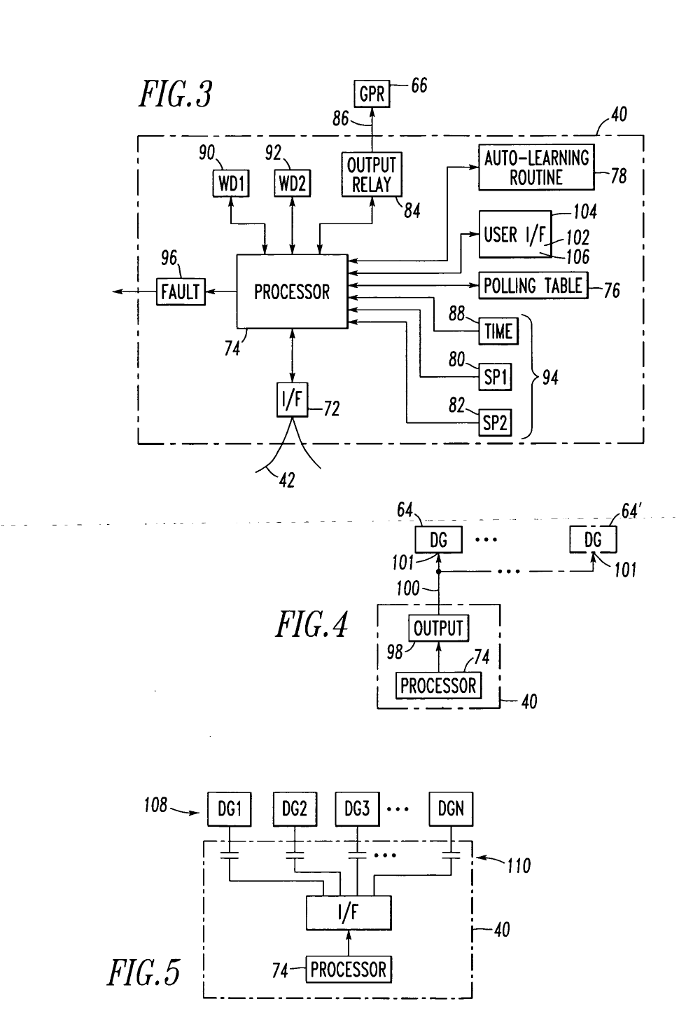

Referring to FIG. 2, a distributed generation (DG) controller 40 connects to a suitable communication network 42 which connects to the communication ports 44,46 of the network protector relays 68,70 of the respective network protectors 48,50. The distributed generation controller 40 is part of a network system 52 for powering a plurality of network loads 54. The network system 52 includes a network bus 56 structured to power the network loads 54, a plurality of power source feeders 58,60,62, the communication network 42, a generator 64 (e.g., without limitation, one or more generators, such as, for example, distributed generators) structured to provide forward power flow to the network bus 56, a generator protector relay (GPR) 66 cooperating with the generator 64, and the plural network protectors 48,50 corresponding to the plural power source feeders, such as 58,60, respectively. The power source feeders 58,60 are structured to provide forward power flow through the respective network protectors 48,50 to the network bus 56. Each of the network protectors 48,50 includes a network protector relay 68,70 including an interface, such as the example communication ports 44,46, respectively, which communicate corresponding power flow information to the communication network 42. The distributed generation controller 40 cooperates with the generator protector relay 66. The distributed generation controller 40 includes an interface (I/F), such as the example communication port 72, which receives the power flow information from the communication network 42. As shown in FIG. 3, the distributed generation controller 40 includes a processor 74 determining whether there is forward power flow through the network protectors 48,50 to the network bus 56 of FIG. 2, enabling the generator protector relay 66 responsive to the forward power flow through the network protectors 48,50 to the network bus 56, and reducing output from the generator 64 (FIG. 2) responsive to the forward power flow through at least one of the network protectors 48,50 being less than a predetermined amount.

### EXAMPLE 1

The example communication network 42 includes a twisted pair, daisy chain among the interfaces 44,46 of the network protector relays 68,70 and the interface 72 of the controller 40.

### EXAMPLE 2

The communication network 42 may be an INCOM network between the interfaces 44,46 of the network protector relays 68,70 and the interface 72 of the controller 40. Examples of the INCOM network and protocol are disclosed in U.S. Pat. Nos. 4,644,547; 4,644,566; 4,653,073; 5,315,531; 5,548,523; 5,627,716; 5,815,364; and 6,055,145, which are incorporated by reference herein. The network 42 or the controller 40 may include an uplink port (not shown) or communication port (not shown) to allow a supervisory system (not shown) to monitor the state of the various networked devices.

### EXAMPLE 3

The interfaces 44,46 of the network protector relays 68,70 are associated with corresponding addresses. The controller processor 74 of FIG. 3 includes a polling table 76 and an auto-learning routine 78, which auto-learns at least some of the network protector relay interfaces, such as 44,46, on the communication network 42, and which adds the corresponding addresses of the interfaces of the network protector relays to the polling table 76. In this example, first, the distributed generation controller 40 powers up and auto-learns the nodes represented by communication-enabled network protectors 48,50 on the communication network 42. Then, after all nodes have been found, including displays, gateways and communication proxy servers (not shown), the addresses of those nodes are added to the polling table 76 along with the authenticated network protectors 48,50. Next, for the network protectors 48,50, the controller 40 polls each of those nodes, in order to read the corresponding power flow status information. Then, the controller 40 evaluates the power flow through each of the network protectors 48,50 relative to corresponding predetermined power setpoints (e.g., thresholds), such as 80,82.

### EXAMPLE 4

As one example application, the controller 40 provides an “ON-OFF” mode. As long as the forward power flow is above a predetermined lower setpoint, such as 80, the distributed generation controller 40 keeps an output relay 84 (FIG. 3) energized. The corresponding output relay contact 86 is then used as a permissive contact by the distributed generator 64 through the generator protector relay 66. The interconnection wiring between the output relay contact 86 and the distributed generator 64 forms a permissive circuit. For example, the output relay 84 may connect to the generator protector relay 66, the generator 64 (e.g., engine control logic) or both.

An engine typically includes built-in control logic that supports functions, such as, for example, speed control (also called a governor), voltage control (also called a voltage regulator), and various alarms and shutdowns, such as, for example, high temperatures and high and low pressures. Engine control logic systems typically include a place for a remote kill switch (e.g., a mushroom head pushbutton). One option is to wire the controller 40 to this circuit as well as to the protector relay 66, although it could be wired to just one or the other. If the output relay 84 de-energizes, then the relay contact 86 changes state. This is interpreted by the distributed generator 64 as a signal to shut down and lock out. The same occurs if the integrity of the interconnection wiring is accidentally violated.

### EXAMPLE 5

In this example, the output relay 84 controls the generator protector relay 66. The controller processor 74 de-energizes the output relay 84 responsive to the forward power flow through at least one of the network protectors 48,50 being less than the predetermined setpoint 80, in order to shut down the generator 64. The controller processor 74 re-energizes the output relay 84 responsive to the forward power flow through the network protectors 48,50 to the network bus 56 being greater than the predetermined setpoint 80, in order to restart the generator 64.

### EXAMPLE 6

The controller processor 74 repetitively polls the communication network 42 to receive the power flow information therefrom. If the distributed generation controller 40 determines that the forward power flow is above the predetermined upper (or reset) setpoint 82, then the distributed generation controller 40 re-energizes the output relay 84 that controls the distributed generator 64. The distributed generator 64, in turn, interprets this as a permission to start.

### EXAMPLE 7

The upper (or reset) setpoint 82 is greater than the lower setpoint 80 by a suitable safety margin, which is selected to prevent control hunting for a suitable predetermined period of time 88. For example, hunting (or cycling) in this context is a repetitive and frequent insertion and removal of the distributed generator 64, whereas the controller 40 reacts to the change of the flow through the network protector, which is caused by insertion or removal of the distributed generator 64 itself, and reacts in the opposite direction. This phenomenon could otherwise add mechanical stresses to the network system 52 and should be prevented by a deliberate setting in the controller 40 chosen not to react to its own actions.

For example, a connect setpoint may define that if the lowest power through any network protector (NWP) is above 150 kW, then the controller 40 is permitted to start the generator, but if that lowest NWP power drops below 50 kW, then it must shut off the generator. Further assuming that two NWPs and the sources are exactly balanced (i.e., one-half of the load requirements is sourced from each NWP, if a 200 kW generator is added to the network bus 56, then that will reduce each NWP load by 100 kW. Further assuming 151 kW forward power on each NWP when starting the generator, this drops the power flow for each NWP by 100 kW, meaning there is 51 kW left flowing through each NWP. That is only 1 kW away from causing a generator shut down in this example. As a further assumption, if an elevator descended and regenerated power of, for example, 10 kW, then that would reduce the building to 41 kW and cause the generator to shut down. Then, after the generator is off and the elevator has stopped, the power jumps back up to 151 kW on each circuit where it was before and the generator would restart. This hunting back and forth cycle would than be repeated. The solution is to make the difference between when the generator starts and when it stops much greater than the generator rating divided by the number of closed NWPs. For an example deadband of 100 kW (=150 kW-50 kW), with two NWPs closed and one 200 kW generator (200 kW/2=100 kW), those two values of deadband and generator-power-shared are too close to each other. Hence, in this example, the deadband would need to be significantly greater than 100 kW (e.g., 200 kW).

### EXAMPLE 8

In order to ensure the integrity of the communication network 42, two “watchdog timers” 90,92 are preferably employed. The first watchdog timer 90 monitors loss of communications with a previously communicating node. The second watchdog timer 92 monitors the health of the distributed generation controller 40.

### EXAMPLE 9

The distributed generation controller 40 preferably performs various internal health checks including, for example, verification of checksums of memory 94 (e.g., volatile; non-volatile) and verification of the integrity of communications on the communication network 42. If any of these health checks fail, then the distributed generation controller 40 de-energizes the output relay 84 (e.g., which drives an example form C relay contact 86) that, otherwise, permits the distributed generator 64 to start and run. For example, such self-checking ensures the integrity of the network system 52. A failed integrity check shuts down and prohibits restart of the distributed generator 64 as a precaution. A separate “fault” relay 96 on the distributed generation controller 40 is also preferably energized to annunciate the fault, while a status display (not shown) preferably indicates a corresponding fault code.

### EXAMPLE 10

As shown in FIG. 4, in addition to the output of the permissive contacts, such as 86 (FIG. 3), the distributed generation controller 40 may employ a suitable analog or digital output 98 including a bias signal 100 which is employed to continuously, periodically or repetitively adjust the input 101 of one or more suitable distributed generators, such as 64, having that adjustment capability. This is referred to as a “follower” mode. In the “follower” mode, the distributed generation controller 40 adjusts the output bias signal 100 relative to the instantaneous forward power when between the lower and upper setpoints 80,82. The controller 40 may “lock” onto a selected (reference) one of the network protectors 48,50 or may seek one of the network protectors 48,50 having the minimum load.

For example, the controller 40 should preferably always “know” which is the NWP with the minimum loading, although a user-selectable “reference” NWP can be of benefit in some fixed spot network applications. This is preferred for a network with constantly changing configurations, such as the reduced configuration after the lowest loaded NWP does trip, in which case the next lowest loaded NWP becomes a reference.

The goal is to ensure that forward power flow through any NWP never drops to such a low level that a load reduction causes the NWP to open. NWPs share power inversely proportional to their circuit impedances (i.e., higher impedances supply less power) and proportional to the difference between their source voltage and the network voltage (i.e., higher voltage differences supply more power). Since one cannot get precisely matched impedances or voltages between NWPs sourcing the network, by definition one NWP will supply the least amount of power. That NWP is the important NWP to monitor since low forward power flow is a problem and the first NWP to trip will be that one.

For example, since the controller 40 monitors each NWP, it knows which NWP has the lowest forward power flow of the group. Alternatively, the reference may be entered as a setpoint, since there are systems where the impedance and voltage differences between NWPs remain constant over the life of the installation, so the NWP with the lowest forward power flow will remain the NWP with the lowest power for as long as the network configuration (i.e., which NWPs are closed, which are open, which substation breakers are closed, and which are open, all of which can change the upstream impedance and voltage to a particular NWP) remains the same. One benefit of monitoring only one NWP within a group of NWPs, if employed, is that the network update speed for the one NWP can be quite fast.

### EXAMPLE 11

The generator 64 may be a plurality of distributed generators, such as DG 64,64′ of FIG. 4. The controller processor 74 may adjust the bias signal 100 to adjust the input 101 of the distributed generators 64,64′.

### EXAMPLE 12

The distributed generation controller 40 may operate its bias signal 100 and output relay 84 as a function of the real-time power flowing through and the status of each of the network protectors 48,50. For example, a user-selectable logic function 102 selected through a suitable user interface 104 of FIG. 3 may be employed to adjust power output from, or even trip a distributed generator, such as 64, based on a predetermined maximum number (or percentage) of out-of-limit network protectors 48,50. A similar logic function 106 may be employed to permit the reconnection of distributed generators, such as 64, based on a predetermined minimum number (or percentage) of closed network protectors 48,50.

### EXAMPLE 13

The controller processor 74 may be structured through one of the user-selectable logic functions 102,106 to adjust power output from or trip at least one of the distributed generators 64 based upon a predetermined count or percentage of the closed network protectors 48,50 to the network bus 56 being less than a predetermined setpoint (e.g., without limitation, any suitable rule; if there are three NWPs, the rule may be that unless at least 50% of the NWPs are energized, the controller 40 cannot start the generator, or that two of the three NWPs must be closed).

The controller processor 74 may trip the one or more distributed generators 64 based upon the predetermined count being less than the predetermined setpoint. The controller processor 74 may reset the one or more distributed generators 64 based upon the predetermined count being greater than the predetermined setpoint.

### EXAMPLE 14

As an alternative to Example 13, if one or more non-adjustable distributed generators 108 are employed, then, as shown in FIG. 5, one or more shedding contacts 110 may be employed for staged distributed generation shedding.

The power setpoints (e.g., thresholds) 80,82 of FIG. 3 may be predetermined by a wide range of suitable methods. A few examples are set forth in Examples 15 and 16.

### EXAMPLE 15

The setpoints 80,82 are user-selectable by the user interface 104 (e.g., without limitation, a suitable switch, such as a DIP switch or rotary switch) on the distributed generation controller 40. The user interface 104 is preferably structured to select, enter or adjust the first and second setpoints 80,82 and the predetermined period of time 88.

### EXAMPLE 16

The setpoints 80,82 are values (e.g., without limitation, register values) stored in distributed generation controller memory 94 (e.g., without limitation, non-volatile memory) and programmed through the user interface 104 (e.g., without limitation, a computer; a hand-held computer; another suitable interface).

### EXAMPLE 17

The upper (reset) setpoint 82 and the suitable predetermined period of time 88 of Example 7 may be set by any suitable method, such as, for example, the methods discussed above in connection with Examples 15 and 16 for the power setpoints (e.g., thresholds) 80,82.

### EXAMPLE 18

Where there are plural distributed generation sources 64 or a number (i.e., one or more) of distributed generation sources having an adjustable output, the network system 52 may significantly improve distributed generation asset utilization.

For example, since a power system has paid for the generator, whether used or not, the money spent on this generator will have a better payback if the system can use it rather than it just being idle. The premise is that during some portion of the time it makes financial sense to run the generator because the generator can produce power at relatively less expense than purchasing it from the utility. In that case, the system seeks to supply as much power from the generator as possible. However, if the control interconnection between the controller 40 and the generator is only an ON-OFF choice, then there may be a situation where the generator output may be so large that connecting it to the network bus would result in reverse power flow from the network. In that case, the system needs a smaller generator. To “make” a smaller generator out of a larger one, the system connects a bias signal from the controller to the governor external speed trim input. When the controller 40 throttles back, the generator output decreases. In this manner, the system can run the generator and provide the lower cost power, but without supplying so much power that it trips the NWP(s).

Where generators with adjustable output cannot be applied, a bank of smaller generators individually connected may be employed instead.

### EXAMPLE 19

Preferably, the example communication network 42 prevents an external system (not shown) from adversely affecting the throughput or timing of the communications, while providing access to data from the network protectors 48,50.

### EXAMPLE 20

The example network system 52 preferably employs a fail-safe design. For example, if the communication network 42 fails in any way, then the individual network protectors 48,50 are not affected, although the distributed generator 64 is shut down as a safety precaution. The communication network 42 may include a pair of conductors. The controller processor 74 may de-energize the output relay 84 responsive to a broken or shorted one of the conductors, or other loss of network communication, in order to shut down the generator 64.

The example network system 52 eliminates the need for bringing current sensing and voltage sensing wiring out of a network protector enclosure (e.g., submersible vessel) (not shown), and does not require or employ additional current and/or voltage transformers or electrical connections to such existing transformers. As a result, this greatly reduces the installation complexity and cost and, also, improves reliability.

The network system 52 does not require separate underpower relays or separate timers (not shown, but part of the underpower relays 8 and 10 of FIG. 1 and disposed between the underpower relays and the output contacts that drive the signals 24,26), thereby resulting in less complexity and lower cost. The network system 52 employs signals that already exist in, for example, microprocessor-based network protector relays, such as 68,70, employed by the respective network protectors 48,50. The example controller 40 reads the direction and magnitude of power flow through the various network protectors 48,50 over the communication network 42 employed by the network protector relays 68,70, thereby eliminating the need to tap into the current sensing and voltage sensing wiring of the network protectors 48,50. This reduces the hazard of exposing current sensing and voltage sensing circuits external to the network protector enclosures.

The example network system 52 also saves space and significantly reduces the cost of installation, since less equipment and labor time are needed. For example, compared to the system 1 (FIG. 1) using conventional underpower relays 8,10, the example network system 52 employs about 80% to about 90% less space and represents a fraction of the interconnection complexity and costs.

A significant enhancement of functionality is also realized since the example network system 52 allows continuous or regular adjustment of the distributed generation output as opposed to mere ON/OFF functionality, thereby resulting in better distributed generation asset utilization. The functionality improvement comes from the ability of the controller 40 to provide continuous or regular generation shedding or generation output adjustment as opposed to only a discrete output (relay contact 86). This capability may be important when the distributed generator output is adjustable or when several units operate in parallel at the same network bus.

The reliability gains come from the elimination of the additional current sensing and voltage sensing wiring outside the network protector enclosure as well as the elimination of a potential breach of the enclosure. This, further, eliminates the potential of externally caused network protector malfunctions. Another distinct benefit of this approach is that the network system 52 is readily extensible in both the count of network protectors and the physical distances therebetween.

Although the controller 40 and processor 74 are disclosed, it will be appreciated that a combination of one or more of analog, digital and/or processor-based circuits may be employed.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A network system for powering a plurality of network loads, said network system comprising:
a network bus structured to power said network loads;
a plurality of power source feeders;
a communication network;
a generator structured to provide forward power flow to said network bus;
a generator protector relay cooperating with said generator;
a plurality of network protectors corresponding to said power source feeders, said power source feeders being structured to provide forward power flow through corresponding ones of said network protectors to said network bus, each of said network protectors comprising a network protector relay including an interface communicating power flow information to said communication network; and
a controller cooperating with said generator protector relay, said controller comprising an interface receiving said power flow information from said communication network and a processor determining whether there is forward power flow through said network protectors to said network bus, enabling said generator protector relay responsive to said forward power flow through said network protectors to said network bus, and reducing output from said generator responsive to said forward power flow through at least one of said network protectors being less than a predetermined amount.

2. The network system of claim 1 wherein the interfaces of said network protector relays are associated with corresponding addresses; and wherein the processor of said controller comprises a polling table and an auto-learning routine, which auto-learns at least some of the interfaces of said network protector relays on said communication network, and which adds the corresponding addresses of the interfaces of said network protector relays to said polling table.

3. The network system of claim 1 wherein said communication network comprises a twisted pair, daisy chain among the interfaces of said network protector relays and the interface of said controller.

4. The network system of claim 1 wherein said controller further comprises an output relay controlling said generator protector relay; and wherein the processor of said controller de-energizes said output relay responsive to said forward power flow through at least one of said network protectors being less than a predetermined setpoint, in order to shut down said generator.

5. The network system of claim 4 wherein the processor of said controller also de-energizes said output relay responsive to loss of communication on said communication channel, in order to shut down said generator.

6. The network system of claim 4 wherein the processor of said controller repetitively polls said communication network to receive said power flow information from said communication network; and wherein the processor of said controller re-energizes said output relay responsive to said forward power flow being greater than said predetermined setpoint, in order to restart said generator.

7. The network system of claim 4 wherein said predetermined setpoint is a first setpoint; wherein the processor of said controller comprises a second setpoint, which is greater than said first setpoint, and a predetermined period of time; and wherein the processor of said controller re-energizes said output relay responsive to said forward power flow being greater than said second setpoint for said predetermined period of time.

8. The network system of claim 7 wherein said controller further comprises a user interface structured to select, enter or adjust said first and second setpoints and said predetermined period of time.

9. The network system of claim 7 wherein said controller further comprises a user interface and a memory; wherein said first and second setpoints are values stored in the memory of said controller; and wherein said values are programmable through said user interface.

10. The network system of claim 1 wherein said controller further comprises a first watchdog timer monitoring loss of communications with a previously communicating one of the interfaces of said network protector relays, and a second watchdog timer monitoring health of said controller.

11. The network system of claim 1 wherein the processor of said controller is structured to perform a plurality of internal health checks, said processor being structured to disable said generator protector relay responsive to failure of any of said internal health checks, thereby shutting down said generator.

12. The network system of claim 1 wherein said generator is at least one distributed generator including an input structured to adjust said forward power flow to said network bus; and wherein the processor of said controller comprises an output having a bias signal structured to continuously, periodically or repetitively adjust the input of said at least one distributed generator.

13. The network system of claim 12 wherein said at least one distributed generator is a plurality of distributed generators; and wherein the processor of said controller further comprises a lower setpoint and an upper setpoint relative to an instantaneous value of said forward power flow between said lower and upper setpoints; and wherein the processor of said controller adjusts the bias signal of the output thereof to adjust the input of said distributed generators.

14. The network system of claim 12 wherein said at least one distributed generator is a plurality of distributed generators; and wherein the processor of said controller further comprises a lower setpoint and an upper setpoint relative to an instantaneous value of said forward power flow between said lower and upper setpoints; and wherein the processor of said controller selects and adjusts one of said distributed generators.

15. The network system of claim 14 wherein the processor of said controller is structured to adjust power output from or trip at least one of said distributed generators based upon a predetermined count of said network protectors having said forward power flow through said network protectors to said network bus being less than a predetermined setpoint.

16. The network system of claim 15 wherein the processor of said controller is structured to trip said at least one of said distributed generators based upon said predetermined count being less than said predetermined setpoint; and wherein the processor of said controller is structured to reset said at least one of said distributed generators based upon said predetermined count being greater than said predetermined setpoint.

17. The network system of claim 1 wherein said generator comprises a plurality of non-adjustable distributed generators; and wherein said controller further comprises a plurality of shedding contacts to provide staged distributed generation shedding.

18. The network system of claim 1 wherein said controller further comprises an output relay controlling said generator protector relay; and wherein the processor of said controller energizes said output relay responsive to said forward power flow through said network protectors to said network bus being greater than a predetermined setpoint.

19. The network system of claim 18 wherein said controller further comprises a user interface structured to select, enter or adjust said predetermined setpoint.

20. The network system of claim 18 wherein said controller further comprises a user interface and a memory; wherein said predetermined setpoint is a value stored in the memory of said controller; and wherein said value is programmable through said user interface.

21. The network system of claim 1 wherein said communication network comprises an INCOM network between the interfaces of said network protector relays and the interface of said controller.
